(19) United States
(12) Patent Application Publication
(10) Pub. No.: US 2010/0121657 A1
(43) Pub. Date: May 13, 2010

(54) Use Of Restricted Links To Send Medical Records Data To Recipients

(75) Inventors: Bryan Rosenberger, Pennsburg, PA (US); Jibu George, Bensalem, PA (US)

Correspondence Address: FISH & ASSOCIATES, PC;ROBERT D. FISH, 2603 Main Street, Suite 1000, Irvine, CA, 92614-6232, US

(73) Assignee: NEXTGEN HEALTHCARE INFORMATION SYSTEMS, INC, Horsham, PA (US)

(21) Appl. No.: 12/598,636

(22) PCT Filed: May 27, 2008
(86) PCT No.: PCT/US08/06707

§ 371 Date: Nov. 23, 2009

Related U.S. Application Data
(60) Provisional application No. 60/940,328, filed on May 25, 2007.

(51) Int. Cl. G06Q 50/00; G06Q 10/00

(52) U.S. Cl. 705/3

(57) ABSTRACT

Methods of aggregating and distributing medical records are presented. Patient data is aggregated from one or more medical providers where the patient data is incomplete with respect to a medical data exchange record (MDER). A data repository, preferrably a third party relative to the providers or a recipient of the data, stores the patient data. When a recipient requests the patient data and is properly authenticated, the patient data is presented to the recipient in standard MDER format. Preferrably, the recipient accesses the data via a limit session link.

This application claims the benefit of priority to U.S. provisional application having Ser. No. 60/940,328, filed on May 25, 2007.

### FIELD OF THE INVENTION

The field of the invention is medical records.

### BACKGROUND

From time to time physicians or other medical providers need to receive medical records from other providers. In many instances the recipient and sender of the information are geographically far apart, and have no personal knowledge of each other.

Conventionally, this problem has been solved by the recipient contacting the sender by phone or fax, and requesting the needed information, and then the sender providing that information by mail, fax, phone and so forth. Unfortunately, such a system can be a significant time drain for both the recipient and sender, (which terms sender should be interpreted broadly to include the medical provider, his/her staff, related organization etc.), and might well involve sending too much or too little data, and the recipient might well receive the data in a non-standard format, or in a format that is quite inconvenient.

Snowden et al. (U.S. patent publication 2002/0026332) describes systems and methods for automated creation and access of patient controlled medical records. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply. One problem with Snowden is that access is controlled entirely by passcodes. Another problem is that a single set of passcodes could be used to access records of many different people. A disgruntled employee could post account and passcode information on the Internet and until the action is identified and rectified, millions of people could theoretically have access to medical records of thousands of different patients.

Gropper et al. (U.S. patent publication 2007/0027715) discuses a healthcare information interchange system where a repository stores healthcare information from a sender and distributes the information to others based on consent rules. However, Gropper fails to adequately limit access to patient data.

Thus, there is still a need for aggregating and distributing medical records to properly authenticated recipients in standard MDER format.

### SUMMARY OF THE INVENTION

The present invention provides apparatus, systems and methods in which a patient's medical data (used herein to mean at least a subset of the patient's medical records) are aggregated and distributed to an authenticated recipient. The patient data stored by the medical data providers is incomplete with respect to a desirable medical data exchange record (MDER). The aggregated patient data can be stored in a third party repository until the data is requested. When a recipient requests the data and is properly authenticated, the patient's data is provided to the recipient in a standard MDER format (e.g., HL7 CDA/CRS or ASTM CCR). In a preferred embodiment, the recipient accesses standardized MDER via a limited session link.

Preferred limited session links comprise URLs sent to the recipient and that have one or more restrictions on their use. Contemplated restrictions include limiting the number of times the link can be accessed (e.g., less than 10 times) or limiting the lifetime of the link (e.g., less than 10 minutes).

Various objects, features, aspects and advantages of the inventive subject matter will become more apparent from the following detailed description of preferred embodiments, along with the accompanying drawings in which like numerals represent like components

### BRIEF DESCRIPTION OF THE DRAWING

FIG. 1 is a schematic of a system that provides a CCR to a recipient upon authentication of the recipient.

FIG. 2 is a schematic of a screen shot of an interface through which a provider selects information to send to a repository.

FIG. 3 is a schematic of a screen shot of a notification to a recipient.

FIG. 4 is a sample screen shot of an authentication interface.

FIG. 5 is a sample screen shot of an authentication challenge using demographics data.

FIG. 6 is a screen shot of an interface to initiate download of authorized portions of a patient's chart or other medical data in CCR format.

### DETAILED DESCRIPTION

### Overview

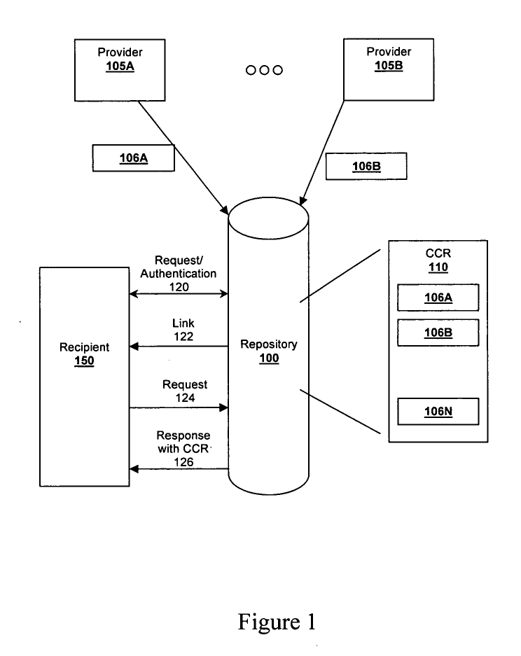

In FIG. 1, repository 100 aggregates patient data 106 (e.g., 106A, 106B, or 106N) from one or more of provider 105A through 105B (collectively referred to as providers 105). Recipient 150 requests a patient's medical records from repository 100 and, after suitable authentication; receives patient data 106 in a standardized MDER format, for example continuity of care record (CCR) 110 based on ASTM Standard E2369-05.

Medical data providers 105 are contemplated to include individuals or institutions having at least a portion of a patient's medical records. Example medical data providers include hospitals, doctor's offices, insurance companies, medical professionals, or other entities that have access to patient data.

In some embodiments, the obtained patient data 106 is incomplete with respect to an MDER. For example, a CCR preferrably includes a patient's health status and identifying information. However, patient data 106A might only include information relating to a patient's allergies (health status) while patient data 106B might only include demographic information (identifying information). Although providers 105 are contemplated to store patient data 106 in a standard format, it is also contemplated that providers 105 can store patient data in a proprietary format other than a standard MDER format.

Repository 100 preferrably comprises a third party service that aggregates patient data 106 and has a database for storing patient data 106. Preferred services are third party with respect to providers 105 and recipient 150 or otherwise lack an affiliation with providers 105 or recipient 150. Example services include the NextGen™ EDS system as described below.

It should be appreciated that repository 100 could interact with providers 105 in near real-time as a patient's medical records are requested. In some embodiments, repository 100 queries providers 105 for data. In other embodiment, providers 105 push patient data 106 to repository 100. It is also contemplated that providers 105 can indicate a time period for which patient data 106 can be stored before being removed from repository 100.

Repository 100 also preferrably comprises suitable software modules for converting patient data 106 from its native format as obtained from providers 105 into a standard MDER format. Repository 100 preferrably converts patient data 106 into an ASTM CCR format or its variants as represented by CCR 110.

Recipient 150 includes an entity that requests a patient's medical data. In a preferred embodiment, recipient 150 includes a patient, a medical provider (e.g., one of providers 105), a medical professional, a healthcare institution, or a software application (e.g., an ERM application).

Recipient 150 access repository 100 via request and authentication exchange 120 which preferrably includes an HTTP exchange. Exchange 120 can include any acceptable information for authentication including biometric information (e.g., finger print, voice recognition, faces recognition, retinal scan, etc. . . . ) relating to recipient 150. In some embodiments, authentication information can be exchanged with a handheld device preferrably a telephony enabled portable computer (e.g., a cell phone, PDA, iPhone™, BlackBerry™, etc. . . . ).

Repository 100 and recipient 150 negotiate authentication through any suitable authentication means. Recipient 150 can be authenticated through a username/password exchange. Other contemplated authentication methods include the use of OpenID™, SecureID™, RADIUS, Kerberos, or other acceptable authentications. In some embodiments, authentication can occur through a third parity service that validates recipient 150 or repository 150, possible using a Versign™ certificate.

Once authentication is complete, recipient 150 could be allowed access to a patient's medical data record (e.g., CCR 110). It is also contemplated, that repository 100 can also secure patient data information from recipient 150. For example, an emergency room technician might be restricted from accessing personal information regarding a patient while still being able to access portions of the records pertaining to the current emergency.

Repository 100 preferrably provides access to a patient's record by sending link 122 to the recipient 150. In a preferred embodiment, repository 100 sends link 122 via an email. However, link 122 can also be sent through any other acceptable methods including instant messages, text messages, web pages, or other network accessible methods.

Preferred links 122 include limited session links that restrict access to the patient's data with respect (a) access time; (b) content; (c) viewing, or (d) number of accesses. For example, link 122 can comprise a one-time use link where once recipient 150 uses link 122 to obtain the patients medical records, link 122 is no longer valid and recipient 150 must re-authenticate to receive a new link. Additionally, link 122 can only be used for a time period as specified by repository 100, providers 105, or other provider of patient data. Preferred time periods are less than 2 days. However, time periods of less than 2 hours are also contemplated including time periods of less than 10 minutes.

In a preferred embodiment, repository 100 controls which portions of the MDER can be accessed by recipient 150 through link 122. Recipient 150 makes a request for the medical records through request 124. In response, repository 100 sends response 126 comprising the controlled medical records in the standard MDER format, for example CCR 110. In the example, shown CCR 110 includes three portions 106A, 106B, and 106N to which recipient 150 is allowed access. Other portions of CCR 110 to which recipient 150 lacks privilege to access can be left blank or can be simply removed from CCR 110.

One skilled in the art will recognize that repository 100 can also provide recipient 150 with alternative formats that can be used to view patient data 106. Contemplated other formats include HL7 formats or possibly proprietary formats in use by providers 105.

Access to portions of the MDER can be controlled as a function at least one of the patient status or characteristic of the recipient, among other parameters associated with the system. Patient status can include health status, traveling status, victim status, or other acceptable attributes. Recipient characteristics are contemplated to comprise indications of the relationship between the patient and the recipient including the following types of relationships familial, patient-doctor, client-insurance company, or other types of affiliations.

Once link 122 has been utilized, repository 100 can optionally send a notification to, among others, at least one of providers 105 or possibly the patient whose records are being accessed. Notification preferrably includes an email; however, any other acceptable form of a notification can also be used, including instant messages, text messages, or web page notifications.

### EXAMPLE

### NextGen™ EDS System

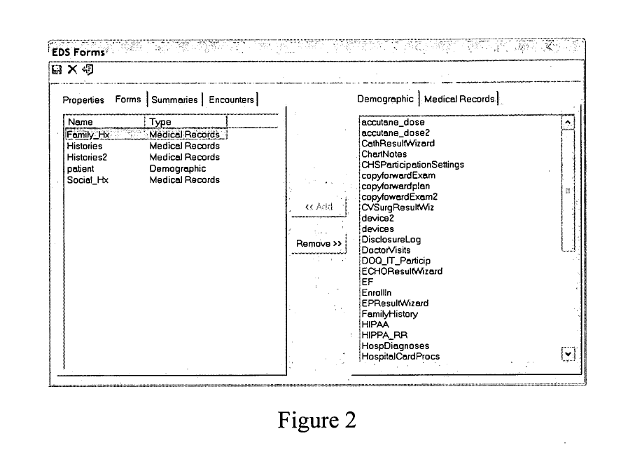

FIG. 2 is a sample screen shot of an interface through which a provider selects information to transmit to the repository, and ultimately to the recipient. The process can be automated to some degree with templates, such that the provider has a pre-selected set of data that he/she/it typically sends. It is contemplated that different templates could be used for different purposes depending on characteristics of the recipient (e.g., specialty), or on status of the patient (e.g., accident victim, vacationer, etc. . . . ).

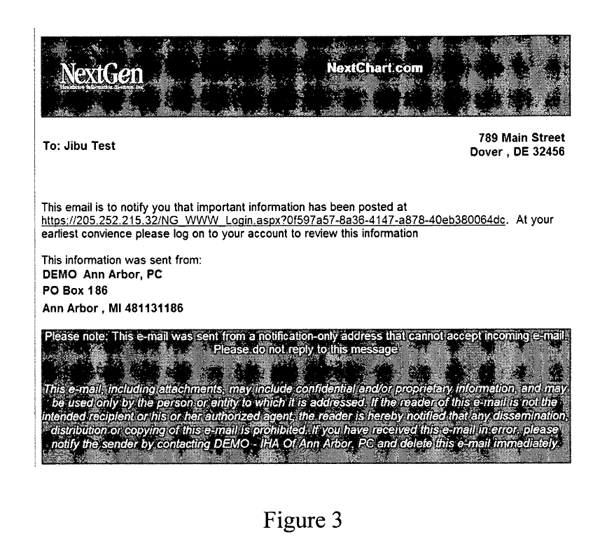

FIG. 3 is a sample screen shot of a notification to a recipient. In preferred embodiments the provider sends the data to a repository, and can limit access with respect to one or more of: (a) access time; (b) content; (c) viewing or (d) accesses. Thus, for example, a link could be active for only 2 days, 2 hours, or only 10 minutes or less. It is also contemplated that links could be active for only a set number of accesses. If the recipient accesses the data using the link, and then closes the interface to get lunch, he might be unable to use the same link again, even though the pre-set time period has not yet expired. Limitations could also be placed on what the recipient can do with the data. At one extreme the recipient could be restricted to viewing the data, and at another extreme the recipient could download, print, modify, or do anything else he wants with the data.

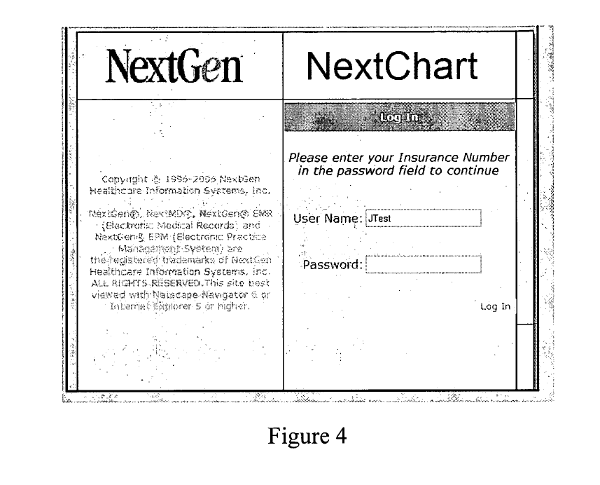

FIG. 4 is a sample screen shot of an authentication interface. In this particular example, the recipient has accessed the link, and is now challenged by the repository for user and passes codes, a user name and password for example. This is an example of post-link authentication. It is alternatively or additionally contemplated that authorization could occur on a pre-link basis, i.e., before the link is sent to the recipient. A third party authenticator is preferred for pre-link authentication, because such use can provide additional assurances that the recipient and/or sender are who they claim to be.

It is still further contemplated that authentication could involve information other than mere passcodes, for example finger prints, retinal scans and other biometric information. Such information could advantageously be transmitted through a cell phone, PDA, iPhone™, Blackberry™ or other telephony enabled portable computer, and could be derived from the patient, the doctor, or any other source.

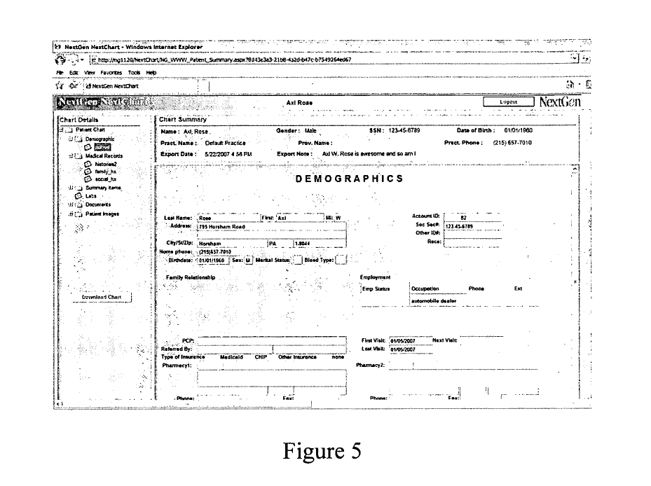

FIG. 5 is a sample screen shot of an authentication challenge using demographics data. It should be understood that these and all other drawing figures and descriptive text relate to specific embodiments of aspects of the inventive subject matter. That subject matter is considered to be much broader than these specific embodiments.

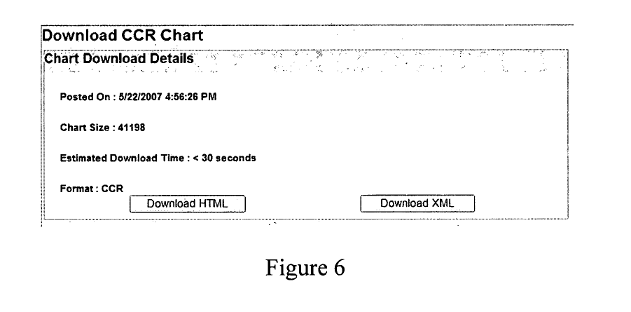

FIG. 6 is a sample screen shot of an interface that could be used to initiate download of authorized portions of a patient's chart or other medical data a standard MDER format. Preferred formats include ASTM continuity of care record (CCR) format based on ASTM Standard E2369-05 or its variants. Data is preferably sent to the repository in a CCR or other standard compliant format. At the recipient's end, the data can be displayed in any suitable format, and it is preferred that a recipient could be provided with alternative formats with which to view the data. Other contemplated formats include HL7 Clinical Document Architecture (CDA) or HL7 Care Record Summary (CRS). One should appreciate that any standard MDER format can be utilized while still remaining with in the scope of the inventive subject matter.

In yet other aspects, notification can be sent to at least one of a provider or the patient that the link has utilized the link. The repository also preferrably maintains a usage log.

Especially preferred embodiments thus allow for secure deployment of a patient's medical data to the patient, a doctor, medical professional, hospital or other recipient, through a system that packages and posts the data via a secure client/web service model. The recipient is notified of the availability of the hosted data, by means of a unique one-time, one-recipient URL, which provides access to that single data, and has mechanisms built in to expire the link after a predetermined number of days. The URL link connects the recipient to a secure website running under HTTPS, who is then challenged, possibly with a piece of demographic data configurable per a NextGen™ EMR or other proprietary website. Upon successfully presenting this information they are allowed access to the data.

Once logged in to the secure Website the recipient can choose to download their data in a standardized format i.e., the CCR that allows for that data to then be freely exchanged with any EMR application that supports the CCR feature. Through the use of templates and formsets, recipients can augment the information in the CCR with additional forms that can also be packaged and deployed for other parties to view. The preferred NextGen's™ EDS System allows for packaged XML Forms and XSL transforms that allows for the independent formsets to live on their own and be viewed with merely a web browser.

Thus, specific embodiments and applications of transferring a patient's medical data from a sender to a recipient have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of aggregating and distributing medical records, comprising:
aggregating patient data from a plurality of medical data providers, where the patient data from each provider is incomplete with respect to a medical data exchange record (MDER);
storing the patient data in a third party repository; and
upon receiving a request from a recipient and negotiating authentication of the recipient, using a limited session link to provide at least some of the patient data to the recipient in a standard MDER format.

2. The method of claim 1, wherein the step of providing access to the MDER includes sending the recipient the limited session link.

3. The method of claim 2, wherein the limited session link comprises a one time use link.

4. The method of claim 2, wherein the step of sending includes sending an email by a sender.

5. The method of claim 4, wherein the limited sessions link expires after a period of time designated by the sender.

6. The method of claim 1, wherein the patient data from at least one of the plurality of medical data providers comprises data stored in a proprietary format.

7. The method of claim 1, further comprising using a third party authenticator to negotiate authentication.

8. The method of claim 1, further comprising securing information from the recipient as a result from negotiating authentication.

9. The method of claim 1, wherein negotiating authentication comprises using biometric information from at least one of the recipient, a medical professional, and a patient.

10. The method of claim 1, wherein negotiating authentication comprises transmitting information through a telephony enabled portable computer.

11. The method of claim 1, further comprising restricting portions of the MDER as a function of an authentication of the recipient.

12. The method of claim 11, further comprising controlling which portions of the MDER can be accessed by the recipient via the limited session link.

13. The method of claim 12, wherein the step of controlling comprises the sending a template that distinguishes among the portions as a function of at least one of patient status, and a characteristic of the recipient.

14. The method of claim 1, further comprising providing the recipient with alternative formats with which to view the data.

15. The method of claim 1, further comprising providing notification to at least one of the plurality of providers, and a patient that the recipient has utilized the link.
